(19) United States
(12) Patent Application Publication
(10) Pub. No.: US 2015/0008717 A1
(43) Pub. Date: Jan. 8, 2015

(54) CHAIR OR SEAT IN PLASTIC MATERIAL WITH COVERING AND METHOD FOR OBTAINING IT

(71) Applicant: IVOPLAST SrL, Villa del Conte (PD) (IT)

(72) Inventor: Gianfranco CERON, Villa Del Conte (IT)

(73) Assignee: IVOPLAST Srl, Villa Del Conte (IT)

(21) Appl. No.: 14/376,948

(22) PCT Filed: Feb. 20, 2012
(86) PCT No.: PCT/IB2012/050754

§ 371 Date: Aug. 6, 2014

(30) Foreign Application Priority Data
Feb. 16, 2012 (IT) PD2012A000038

(51) Int. Cl. A47C 5/12; B29C 45/14

(52) U.S. Cl. CPC A47C 5/12; B29C 45/14065; B29C 2045/14155
USPC 297/452.18; 264/263; 264/571; 264/161

(57) ABSTRACT

The invention is a chair or seat in general, comprising at least one hull (P) obtained through injection moulding or injection-compression moulding of the plastic material (P1) in moulds (S) having the shape of said hull (P) to be obtained, and wherein said layer of covering material (M) has been positioned so that it adheres to part of said mould (5) before the injection of the plastic material (P1), so that said layer of covering material (M) is visible and adheres to the surface of said plastic hull (P) or part directly moulded on the covering layer (M).

The present patent concerns chairs, stools, armchairs and seats in general, and in particular it concerns a new type of chair or seat generally in a plastic material with covering in fabric or imitation fabric, leather, imitation leather or eco leather, and a method for obtaining it.

Chairs are presently made of wood, plastic material or twisted vegetable fibres.

Wooden chairs are easy to produce and to paint but they pose the drawback of being rather heavy, of requiring regular maintenance and/or painting, especially if they are placed or left outdoors.

In order to reproduce drawings, images or artistic graphics on wooden chairs it is necessary to do it manually or to apply a printed support to the surface of the piece of furniture.

Manual reproduction is very expensive and can be used only for a reduced number of objects.

The application of the printed support to the surface of the chair has the following advantages: it requires the application of a further paint layer or transparent protective layer, it is difficult to apply to shapes with small radius curves or featuring many grooves.

The chairs in plastic materials are easy to produce and easy to paint but they pose the drawback that it is difficult to combine them with other materials and obtain a long-lasting result.

The chairs in twisted vegetable fibres are very light, they can be painted uniformly or in portions or areas but they cannot be painted reproducing detailed drawings or images and it is not possible to apply printed supports to them.

Low-pressure printing systems are known that have the defect of requiring very long cycles and that are thus characterized by low productivity.

Plastic chairs are known in which the backrest and the seat are separated from each other or which form a single hull, obtained from a mould, and wherein the backrest and the seat are completely or partially covered with a natural or synthetic fabric, with a natural or synthetic padding, if provided. At present, in order to apply said covering with the respective padding, if provided, a procedure is employed according to which the covering fabric is produced separately, with any padding, for example in a foam material or another type of material, applied, glued or in any case constrained to one side of said fabric.

Said covering with padding, if provided, is then applied to the hull of the plastic chair, onto which glue has been previously spread.

The glue is often distributed on the entire surface of the hull, on the seating side and if necessary also on the opposite side, and the covering is thus applied to both sides.

The covering is then trimmed following the profile of the hull and finally sewn or in any case welded along the edges. Alternatively the covering, ready, shaped and sewn, is fitted on the hull and attached to it by means of the glue previously spread thereon, in order to be successively sewn along the still open side used to fit it.

This procedure, therefore, includes a long series of steps, many of which need manual operations and thus the employment of labour, for example the application of the glue and of the covering, the trimming and the sewing steps.

This procedure involves long execution times and high production costs due to the operations that have to be carried out manually.

In order to overcome these drawbacks, a new type of chair with plastic hull or parts has been designed and constructed, said hull or parts being completely or partially covered with a fabric or imitation fabric, leather, imitation leather or eco leather, with or without padding.

The main object of the present invention is to provide a finished chair, with a rigid structure and a covering applied by means of a high efficiency and high productivity injection moulding process, completely automated and with no need for complex glueing and sewing operations requiring the employment of labour.

It is another object of the present invention to avoid the use of glue for the application of the covering to the hull. Said application of the covering, in fact, is carried out during the moulding step, as the molten plastic material is injected directly on the covering fitted in the mould, with no further steps. It is another object of the present invention to provide localized paddings or paddings that in any case are distributed on the seat or backrest of the chair or on the hull in general, applied between the covering and the hull directly during the moulding step, with no further intermediate or successive steps. It is one object of the present invention to obtain chairs with a rigid structure, in fabric or imitation fabric, or leather, imitation leather or eco leather, resistant to wear.

It is one object of the present patent to obtain chairs covered with any material without modifying in any way the aesthetic characteristics of the covering material.

An advantage offered by the present invention lies in that it ensures limited production costs.

Another advantage lies in that with a high-pressure injection process it is possible to obtain elements with reduced thickness compared to the known art, with consequent further savings in terms of material and thus of costs and weight.

These and other direct and complementary objects are achieved by the new chairs with a plastic hull or one or more plastic parts, completely or partially covered with fabric or imitation fabric, or leather, imitation leather or eco leather.

Said parts or hull made of a plastic material feature suitable rigidity, so that it is possible to obtain chairs that do not need cores or inner reinforcing rigid elements or bonding agents.

The covering material may be constituted by fabric, non woven fabric or a similar material, or even by a material like leather, imitation leather or eco leather or their derivatives.

The plastic material of which the hull is made and the covering material are joined to each other through injection moulding or injection-compression moulding, without using glues.

The layer of covering material, in the appropriate shape, is positioned inside a mould having, in negative, the shape of the hull or part of the chair to be obtained. In particular, said covering layer is positioned so that it adheres to the inner surface of part of the mould, wherein the complete adhesion of the covering material layer is guaranteed, for example, by the use of air suction systems mounted from the inside of the mould and/or mechanical systems like small needles, coupling clips, knurled surfaces or anti slip surfaces, or other elements suitable for this purpose.

The molten plastic material is successively injected in the mould. The moulded object obtained in this way is thus formed by a plastic hull or part joined without glue to said covering layer, which remains permanently attached to the plastic material with no need for further glueing operations.

In particular, said covering layer is placed inside the mould in such a way as to be applied to the entirety or part of one side of the hull obtained, for example on the seating side of the hull or on the opposite side.

The new chair can also be totally or partially covered on both sides.

In this case, according to an embodiment, the new chair comprises one pair of said parts or hulls, carried out individually, each one with its covering applied to the opposite side with respect to the application side of the other hull, so that by coupling the two hulls by joining their uncovered sides it is possible to obtain said chair covered on both sides.

Said coupling of the two hulls can be obtained through the interposition of adhesive substances or of a layer of rubber or another material suited to guarantee that the two hulls adhere to each other.

According to an alternative embodiment, the new chair is obtained by positioning a first covering in the mould, for example on the side corresponding to the seating side. Then the injection moulding process is performed to obtain the hull or part of the chair. The mould is opened, the covering is applied to the side where it is missing and the mould is closed, leaving space for a further injection of plastic material, thus obtaining a single final hull with double covering.

Alternatively, according to the invention two covering layers can be laid on the opposite surface sides of the mould, successively proceeding to the injection of molten plastic material between the two covering layers and forming the core of the product, which remains permanently attached to the coverings, with no need for further glueing operations.

According to the invention, during the moulding process any lateral flash or exceeding parts of the covering layer may be trimmed, for example using blades or cutting edges provided on the mould.

According to the invention, said covering layer may comprise also one or more padding elements, joined to the covering itself, and thus located inside the mould together with the covering, in such a way as to be directed towards the inside of the mould.

The resulting product thus comprises said plastic hull obtained by moulding, joined to said covering layer, wherein said one or more padding elements are interposed between said covering layer and said plastic hull.

Said padding elements can be made of synthetic materials, for example foam materials, gel, silicone materials, rubbers or natural materials like cotton, wool, rubber etc.

According to the invention, said hull or part carried out in this way and making up the chair can be provided, at the moment of moulding, with one or more accessories necessary for the composition or assembly of the chair, like leg housings, hinges, closing clips. In this case said accessories are positioned in the mould or on the closing edge of the mould before the injection of the plastic material, so that they are completely or partially incorporated in the plastic material.

According to the invention, the layer of plastic material may have different and various thicknesses, so that said hull or part of the chair can be rigid, semi-rigid or soft and flexible, depending on whether the specific portion is a plane or a bearing partition or a joint element.

According to the invention, said plastic material can in any case be painted or not painted or transparent.

The characteristics of the invention will be highlighted in greater detail in the following description, with reference to the drawings attached as non-limiting examples.

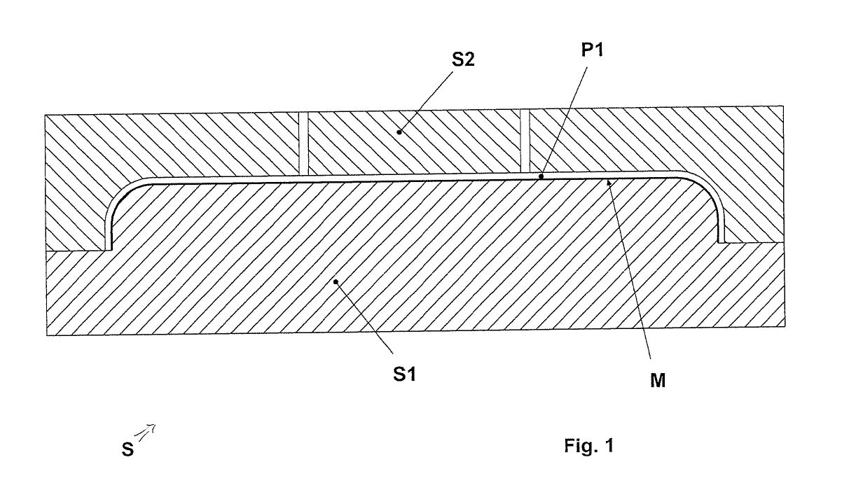

FIG. 1 shows a sectional view of the mould (S) in which the covering layer (M) has been previously positioned and in which the plastic material (P1) is injected in order to obtain the hull (P) of the chair.

FIG. 1a shows a sectional view of the mould (S) in which the covering layer (M) is positioned in advance, with padding elements (M4) already in place.

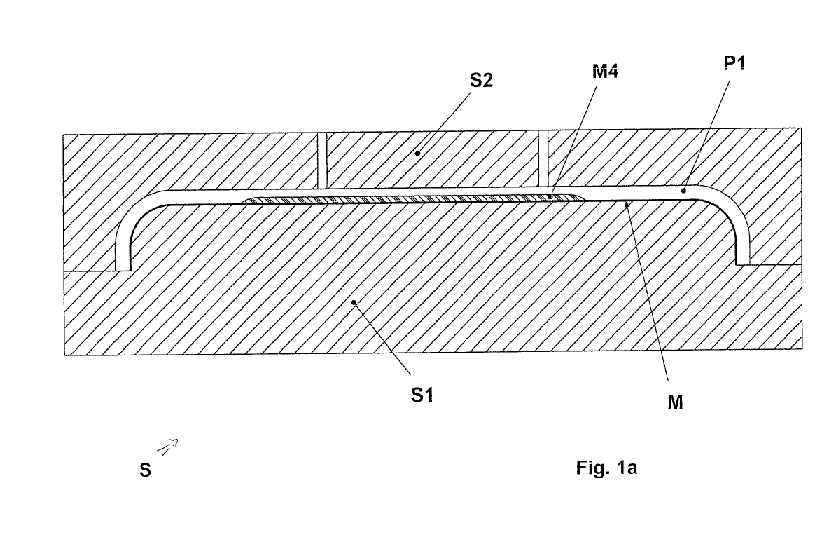

FIG. 2 shows a schematic sectional view of an example of embodiment of a hull (P) with a covering layer (M) applied to one side only, or the seating side (P2) of the hull itself,

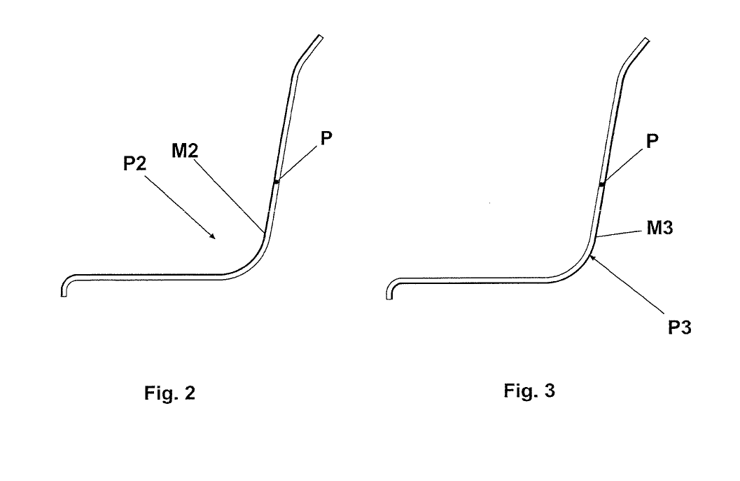

FIG. 3 shows a schematic sectional view of an example of embodiment of a hull (P) with a covering layer (M) applied to the opposite side (P3) of the hull (P)

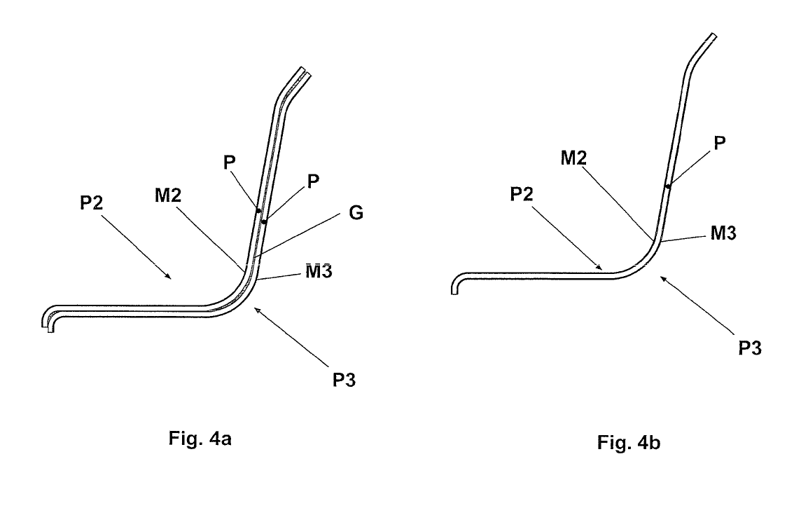

FIGS. 4a and 4b show schematic views of two examples of embodiment of a hull (P) with a covering layer (M1) applied to the seating side (P2) and with a covering layer (M2) applied to the opposite side (M3).

The hull (P) or part making up the chair is made of a plastic material (P1) and is joined to the covering layer (M) by moulding it in a suitable mould (S) consisting, for example, of two dies (S1, S2), as shown in FIG. 1.

The covering layer (M), in the appropriate shape, is positioned inside a mould (S1, S2) having, in negative, the shape of the hull (P) or part of the chair to be obtained.

Said covering layer (M), for example, can be positioned in such a way as to be then located on the entirety or part of the seating side (P2) or on the entirety or part of the opposite side (P3), as shown in FIGS. 2 and 3.

Said covering layer (M) may also comprise one or more padding elements (M4) applied in advance to the covering layer (M).

Said padding elements (M4) can be distributed over the entire covering (M) or over some of its parts only.

The plastic material (P1) is successively injected in the mould (S1, S2).

In order to make a hull (P) or part of the chair with a covering (M2, M3) on both the opposite sides, as shown in FIG. 4a, it is necessary to make two individual hulls (P) with a covering (M2, M3) on one side only (P2, P3), as shown in FIGS. 2 and 3, and then join the two hulls, for example through the interposition of an adhesive substance (G) in general or through a further injection of plastic material into the mould (S).

As an alternative, the hull (P) with a covering (M2, M3) on both the opposite sides, as shown in FIG. 4b, can be obtained through a sequence of two successive moulding operations, a first moulding operation performed by positioning just one covering (M2) on one side of the mould (S) and a second moulding operation performed after opening the mould (S), positioning the second covering (M3) on the opposite side of the mould (S) and closing the mould.

As an alternative, the hull (P) with a covering (M2, M3) on both the opposite sides, as shown in FIG. 4b, can be obtained by positioning the covering on both the opposite sides of the mould, where it remains attached and adherent, and with a single injection moulding operation into the “core” of the hull mould to join the whole.

Therefore, with reference to the above description and the attached drawings, the following claims are expressed.

1. Chair or seat in general, comprising at least one plastic hull (P) and/or one or more plastic parts, obtained through a moulding operation, completely or partially covered with at least one layer of a covering material (M), characterized in that said plastic hull (P) or parts are obtained through injection moulding or injection-compression moulding of the plastic material (P1) in moulds (S) having the shape of said hull (P) or part to be obtained, and wherein said layer of covering material (M) has been positioned so that it adheres to a part of said mould (S) before the injection of the plastic material (P1), so that said layer of covering material (M) is visible and adheres to the surface of said plastic hull (P) or part directly moulded on the covering layer (M).

2. Chair according to claim 1, characterized in that said covering layer (M) is made of fabric and/or imitation fabric and/or leather and/or imitation leather and/or eco leather.

3. Chair according to claim 1, characterized in that said covering layer (M) is applied to the entirety or part of one side of said plastic hull (P) or part, on the seating side (P2) or on the opposite side (P3).

4. Chair according to claim 1, characterized in that it comprises at least one covering layer (M) on the entirety or part of each one of the two opposite sides of said plastic hull (P) or part.

5. Chair according to claim 1, characterized in that it comprises one pair of said parts or hulls (P), each one obtained individually with said covering layer (M) applied to one side only, meaning the opposite side with respect to the side of application to the other hull (P), and wherein said two hulls (P) are joined to each other by coupling said uncovered sides through the interposition of adhesive substances or of a layer of injection moulded molten plastic or another material suited to guarantee that the two hulls (P) adhere to each other.

6. Chair according to claim 1, characterized in that it comprises one or more padding elements (M4) interposed between said covering layer (M) and said plastic hull or part (P), said padding elements (M4) being previously joined to said covering layer (M) and placed inside said mould (S) together with said covering layer (M), facing towards the inside of the mould (S), before the injection of the plastic material (P1), so that they adhere to said plastic part or hull (P), and wherein said padding elements (M4) are distributed over the entire covering (M) or over some parts only.

7. Chair according to claim 6, characterized in that said padding elements (M4) are made of synthetic materials, for example foam materials, gels, silicone materials, rubbers or natural materials like cotton, wool, rubber etc.

8. Chair according to claim 1, characterized in that said hull (P) or part comprises accessories that are necessary for making up or assembling the chair, such as leg housings, hinges, closing clips, and wherein said accessories are positioned in the mould (S), or on the closing edge of the mould (S), before the injection of the plastic material (P1), so that they are incorporated or partially incorporated in the plastic material (P1).

9. Method for making chairs comprising a plastic hull (P) and/or one or more plastic parts, obtained by moulding, completely or partially covered with at least one layer of a covering material (M), according to claim 1, characterized in that it comprises the following steps:
positioning at least one covering layer (M) inside a mould (S) having, in negative, the shape of said hull or of the part of the chair to be obtained, said covering layer (M) being positioned so that it adheres to the inner surface of said mould (S),
injecting molten plastic material (P1) inside said mould (S).

10. Method according to claim 9, characterized in that it comprises the use of air suction systems from the inside of said mould and/or mechanical systems like small needles, coupling clips, knurled or anti slip surfaces, or other systems suitable for this purpose, in order to obtain total adhesion of said layer of covering material (M) to said surface of the mould (S).

11. Method according to claim 9, characterized in that any lateral flash or exceeding parts of said one or more covering layers (M) are trimmed during the moulding step using blades or cutting edges mounted on the mould.

12. Method according to claim 9, characterized in that it also comprises the following steps:
joining one or more padding elements (M4) to said covering layer (M);
positioning said covering layer (M) inside said mould (S) with said padding elements (M4) facing towards the inside of the mould;
injecting plastic material (P1) inside said mould (S).

13. Method for making chairs comprising at least one moulded plastic hull (P) and/or one or more moulded plastic parts with a covering layer on the entirety or part of each side (P2, P3) of the hull or part (P), according to claim 9, characterized in that it comprises the following steps:
preparing a first hull (P) with a covering (M2) on one side (P2);
preparing a second hull (P) with a covering (M3) on an opposite side (P3) with respect to said covered side (P2) of said first hull (P);
joining said two hulls (P) by coupling the respective uncovered sides through the interposition of an adhesive substance (G) in general or through a further injection of a plastic material in the mould (S) between said two hulls (P).

14. Method for making chairs comprising a moulded plastic hull (P) and/or one or more moulded plastic parts with a covering layer on the entirety or part of each side (P2, P3) of the hull or part (P), according to claim 9, characterized in that it comprises the following steps:
positioning a first covering (Ml) in said mould (S), on the side corresponding to one side (P2, P3) of said hull or part to be obtained;
injecting plastic material in order to obtain said hull or part of the chair joined to said first covering (M1);
opening the mould (S) and positioning a second covering (M2) on the opposite side;
further injecting plastic material inside said mould (S), thus obtaining a single hull (P) with double covering.

15. Method for making chairs comprising a moulded plastic hull (P) and/or one or more moulded plastic parts with a covering layer on the entirety or part of each side (P2, P3) of the hull or part (P), according to claim 11, characterized in that it comprises the following steps:
positioning a first covering (M1) in said mould (S), on the side corresponding to one side (P2, P3) of said hull or part to be obtained;
positioning a second covering (M2) after the first covering (M1) on the opposite side of the mould;
injecting molten plastic material in said mould just once, between said two coverings (M1, M2), in order to obtain said hull or part of the chair joined to said first coverings (M1 and M2) with a single injection moulding cycle.
